(19) United States
(12) Patent Application Publication
(10) Pub. No.: US 2008/0206402 A1
(43) Pub. Date: Aug. 28, 2008

(54) Food Products Containing Legume Products and Processes for Producing the Food Products

(76) Inventors: Patricia DeMark, Maroa, IL (US); Richard Grabiel, Decatur, IL (US); Eric White, Decatur, IL (US); Brian Yager, Puyallup, WA (US)

Correspondence Address: ARCHER DANIELS MIDLAND COMPANY, 4666 FARIES PARKWAY, DECATUR, IL, 62526, US

(21) Appl. No.: 12/038,075

(22) Filed: Feb. 27, 2008

Related U.S. Application Data
(60) Provisional application No. 60/903,768, filed on Feb. 27, 2007.

(51) Int. Cl. A23L 1/20; A23L 1/302

(52) U.S. Cl. 426/46; 426/634; 426/62; 426/72

(57) ABSTRACT

Food products containing legume products, as well as processes for producing the food products are disclosed.

### CROSS-REFERENCE TO RELATED APPLICATION(S)

This application claims the benefit of U.S. Provisional Application No. 60/903,768, filed Feb. 27, 2007, the contents of the entirety of which are incorporated by this reference.

### TECHNICAL FIELD

The present invention relates generally to food technology, and more particularly, to food products containing legume powders.

### SUMMARY OF THE INVENTION

In one embodiment, a composition comprises a dehydrated legume product having an increased amount of dietary fiber on a dry weight basis as compared to a legume from which the dehydrated legume product originates. The composition also includes flour. In one embodiment, the dehydrated legume product and the flour are present in the composition in such amounts and processed such that the composition takes the form of cracker.

In another embodiment, a process for producing a product includes admixing a dehydrated legume product with an ingredient, thus producing a mixture. The mixture is fermented and the fermented mixture is combined with flour. The combined fermented mixture and flour are baked, thus producing a cracker.

In an additional embodiment, a composition includes a dehydrated bean powder having an increased amount of dietary fiber on a dry weight basis as compared to a bean from which the dehydrated bean powder originates. The composition further includes flour, shortening, a malt product and an ingredient selected from the group consisting of yeast, a milk product, baking soda, salt, an emulsifier, a dough strengthener, a soluble fiber, and combinations of any thereof. The dehydrated bean powder, the flour, the shortening, the malt product and the ingredient are present in the composition in such amounts and processed such that the composition takes the form of a cracker.

In yet a further embodiment, a composition comprises a dehydrated bean powder having an increased amount of dietary fiber on a dry weight basis as compared to a bean from which the dehydrated bean powder originates. The composition further includes flour, baking powder, and salt. The dehydrated bean powder, the flour, the baking powder and the salt are present in the composition in such amounts and processed such that the composition takes a form selected from the group consisting of a cookie, a pancake, a waffle, a biscuit or a sandwich dough.

Foodstuffs incorporating the compositions of the present invention are also disclosed.

### BEST MODE OF THE INVENTION

In the United States, there is increasing concern over the consumption of high sugar and high fat foods by the population. Replacing such high sugar or high fat foods with foods enhanced in fiber and/or protein is one healthier option.

Legumes are high in protein and fiber. In fact, the 2005 Dietary Guidelines Pyramid lists beans and peas under both the Vegetables, and the Meats and Beans categories, thus, emphasizing the healthy nature of legumes in the diet.

In addition to the emphasis on lower fat and lower sugar diets, other beneficial effects of legumes are becoming apparent. For instance, inositol polyphosphates, which are naturally occurring substances found in most legumes, have been implicated in being able to inhibit the growth of some cancer xenografts. (See, Cancer Resources, 2005; 65: (18), Sep. 15, 2005).

With the increased awareness of the health benefits of legumes, there exists a need for healthier food products and foodstuffs that provide the beneficial nutritional effects of legumes.

Food products containing legume powders or other dehydrated legume products, as well as processes for producing the food products are disclosed. Foodstuffs including legumes or legume products are typically high in fiber and/or protein as compared to a foodstuff not including the legume or legume product. Thus, the incorporation of legumes or legume products into a foodstuff results in a foodstuff having a higher content of fiber and/or protein, while reducing the sugar and/or fat content of the foodstuff.

In one embodiment, a food product or ingredient used in a foodstuff comprises a legume powder. The presence of the legume powder in the foodstuff enhances or increases the amount of fiber and/or protein in the foodstuff, thus, helping a person consuming the foodstuff to meet their Dietary Guidelines for fiber and/or protein intake. In another embodiment, distribution of the foodstuff having the enhanced or increased fiber and/or protein to a population may help increase the nutrition of the population and, potentially, help lower incidences of obesity or other diet related diseases.

In one embodiment, the legume from which the legume powder originates may be of a Phaseolus species (i.e., beans). In other embodiments, the legume may comprise green or yellow peas (i.e., Pisum), lentils (i.e., Lens vulgaris), chickpeas (i.e., Cicera arietenum), soybeans (i.e., Glycine max), peanuts, (i.e., Arachis hypogaea), trefoil (i.e., Lotus corniculatus), and combinations of any thereof. In further embodiments, varieties of beans that may be used to produce the foodstuffs of the present invention include, without limitation, Pinto beans, Great Northern beans, Navy beans, Red beans, Black beans, dark or light Red Kidney beans, Fava beans, Green Baby Lima beans, Pink beans, MYASI beans, Mayocoba beans, Small Red beans, Black Eyed beans, Garbanzo beans, Cranberry beans, White Beans, Rice beans, Butter beans, African Giraffe beans and any combinations thereof.

In various embodiments, a food product or ingredient of the present invention may take various forms including, but not limited to, a cracker. Further, the food product or ingredient may be incorporated into a foodstuff in combination with one or more seasonings or spices in order to enhance the flavor of the foodstuff. In yet other embodiments, processing aids or preservatives may be added to the food product or ingredient in order to affect the functionality and shelf life of the foodstuff.

A cracker of the present invention may be used in combination with various foodstuffs including, but not limited to, soup, chili, gumbo, chowder or other food product. In further embodiments, the cracker of the present invention may be used as a snack food and, optionally, have a seasoning or spice integrated within the cracker or coated on the cracker.

In yet additional embodiments, other ingredients such as antioxidants, food colorants, vitamins, minerals, edible oils or fats, emulsifiers, leavening agents, natural or artificial sweeteners, starches, thickening agents, fiber (including, but not limited to, a soluble fiber or an insoluble fiber), a cellulose (i.e., microcrystalline cellulose or carboxymethylcellulose), maltodextrins, corn-syrup solids, potato starch, corn starch, wheat starch, tapioca starch, a vegetable product, a fruit product, a nut product or combinations of any thereof may be used in conjunction with or incorporated into the foodstuff of the present invention.

In an additional embodiment, a process for producing a food product or ingredient includes combining a legume powder or other dehydrated legume product with at least one other ingredient, water and yeast to produce a mixture, allowing the resulting mixture to ferment for a period of time, combining the fermented product with another ingredient, and subjecting the resulting mixture to heat. In one embodiment, the legume powder may be a dehydrated legume powder.

The legume powder or product may be produced by milling a legume or legume product. In another embodiment, a dehydrated legume product may be used to form the legume powder, and be produced by milling a dehydrated legume or a dehydrated legume product into a powder.

In one embodiment, the dehydrated legume or dehydrated legume product is produced using the process described in US Patent Application 2006/0153965 assigned to Archer Daniels Midland Company of Decatur, Ill., entitled Edible Legume Products published Jul. 13, 2006, the contents of the entirety of which is incorporated by this reference. In another embodiment, the process for dehydrating the legume or legume product may include blanching the legume or legume product, cooking the blanched legume or legume product, and/or dehydrating the cooked legume or legume product to form a dehydrated or reconstitutable legume or legume product. In a further embodiment, water may be used to blanch and/or cook the legumes or legume products, and an organic acid may optionally be added to the blanching water, the cooking water, or both.

In other embodiments, the process for producing the dehydrated legume or dehydrated legume products may include conditioning the legumes or legume products by subjecting the legumes or legume products to hydration; cooking the legumes or legume products; depressurizing the cooked legumes or legume products; and/or dehydrating the legumes or legume products to form a reconstitutable legume or legume product. In other embodiments, the process for dehydrating the legume or legume product may also include use of an organic acid in the hydration, blanching, and/or cooking step, and the process may further include washing and/or destoning raw legumes used in the process.

In a further embodiment, a dehydrated legume, a dehydrated legume flour, a dehydrated legume powder or a dehydrated legume product used in the foodstuffs of the present invention has an increased dietary fiber percentage on a weight basis as compared to a non-dehydrated or raw legume, flour, powder or product. For example, dehydrated Pinto beans produced with the teachings of US Patent Application 2006/0153965 comprise about 27% dietary fiber, while non-dehydrated or raw Pinto beans comprise about 12% dietary fiber; dehydrated Small Red beans produced with the teachings of US Patent Application 2006/0153965 comprises about 23% dietary fiber, while non-dehydrated or raw Small Red beans comprise about 8.9% dietary fiber; dehydrated Black beans produced with the teachings of US Patent Application 2006/0153965 comprise about 29% dietary fiber, while non-dehydrated or raw Black beans comprise about 13.3% dietary fiber; dehydrated Navy beans produced with the teachings of US Patent Application 2006/0153965 comprise about 23% dietary fiber, while non-dehydrated or raw Navy beans comprise about 9.8% dietary fiber; dehydrated Dark Red Kidney beans produced with the teachings of US Patent Application 2006/0153965 comprise about 24% dietary fiber, while non-dehydrated or raw Light Red Kidney beans comprise about 10.6% dietary fiber; and dehydrated Light Red Kidney beans produced with the teachings of US Patent Application 2006/0153965 comprise about 24% dietary fiber, while non-dehydrated or raw Light Red Kidney beans comprise about 10.6% dietary fiber. It will be apparent by those of ordinary skill in the art that the amounts and percentages of dietary fiber in a legume or legume product may vary depending on various factors and that the amounts of fiber disclosed herein are exemplary in nature.

In another embodiment, a dehydrated legume or legume product is subjected to a milling process to produce a dehydrated legume powder. In a further embodiment, the dehydrated legume or legume product is subjected to a form of crushing or pulverizing such as by passage of the dehydrated legume or legume product through a hammermill or universal mill. In one embodiment, the dehydrated legume or legume product is ground in a PC-20 mill. The ground or powdered dehydrated legume or legume product may be passed through a Swecoscreen 60 mesh, wherein the ground or powdered dehydrated legume or legume product has a particle size of less than about 0.250 mm. In another embodiment, the ground or powdered dehydrated legume products are produced such that about 95% of the ground or powdered dehydrated legume product passes through an 80 mesh screen. The ground or powdered dehydrated legume or legume product may further be passed by a magnet to remove any metallic (i.e., iron-containing) contaminants, and further be placed in containers for shipping or placed in a food product. In one embodiment, a composition of the present invention may be produced at a first geographic location and shipped to a second geographic location.

In one embodiment, a food product or ingredient for use in a foodstuff comprises a dehydrated legume powder and another ingredient such as, for example, a flour or a meal. Non-limiting examples of crops that may be used to produce the flour or meal to be used in combination with the de-hydrated legumes, without limitation, include corn, rice, whole wheat, wheat, barley, durum, sorghum, sunflower, canola, oats, flax, potatoes, buckwheat and combinations of any thereof.

In one embodiment, whole wheat flour used in the compositions of the present invention comprises whole wheat flour such as KANSAS DIAMOND™ brand whole wheat flour available from ADM Milling of Overland Park, Kans. The whole wheat flour has a moisture content of at most 14%, a protein content between 12% and 13%, and an ash content of between 1.2-1.6%. The granulation of the whole wheat flour is such that 85% of the flour passes through a US #100 sieve, 12.5% of the flour stays on a US #100 sieve, 1.0% of the flour stays on a US #80 sieve, and 1.5% of the flour stays on a US #60 sieve. In other embodiments, other whole wheat flours may be used. In one embodiment, the whole wheat flour may be ULTRAGRAIN® brand whole wheat flour available from ConAgra Foods.

In other embodiments, various ingredients may be added to the foodstuff in combination with the dehydrated legume powder or the dehydrated legume flour, and the other ingredients such as flour or meal. Examples of such various ingredients include, but are not limited to, proteins such as wheat protein, wheat protein isolate, wheat gluten, buttermilk solids, whey protein, whey protein isolate, milk powders, egg protein, canola protein, pea protein, wheat protein, potato protein, corn protein, sesame protein, sunflower protein, cottonseed protein, copra protein, palm kernel protein, safflower protein, linseed protein, peanut protein, lupin protein, oat protein, soy protein, soy protein concentrates, soy protein isolates and mixtures of any thereof.

In other embodiments, a pre-cooked or dehydrated legume product having utility in the embodiments of the present invention may include, without limitation, a sugar and/or calcium chloride. Non-limiting examples of such legume products are disclosed in Table 1. Other legume products that may be used in the embodiments of the present invention are disclosed in Table 2. The legume products of Tables 1 and 2 are commercially available from Archer Daniels Midland Company of Decatur, Ill.

TABLE 1
Nutritional analysis of bean powders.

| | | | Small | | Great |
|---|---|---|---|---|---|
| | | Black | Red | Navy | Northern |
| | Pinto Bean | Bean | Bean | Bean | Bean |
| Per 100 grams | Powder | Powder | Powder | Powder | Powder |
| Calories | 299 | 311 | 304 | 305 | 319 |
| Calories from fat | 20 | 20 | 17 | 23 | 20 |
| Calories from | 5 | 4 | 4 | 5 | 4 |
| Saturated fat | | | | | |
| Fatty Acid Profile | | | | | |
| Total Fat (g) | 2.27 | 2.27 | 1.88 | 2.55 | 2.27 |
| Saturated Fat (g) | 0.5 | 0.48 | 0.43 | 0.52 | 0.49 |
| Monosaturated Fat (g) | 0.26 | 0.32 | 0.14 | 0.34 | 0.26 |
| Cis/cis polyunsaturated | 1.41 | 1.37 | 1.23 | 1.58 | 1.42 |
| fat (g) | | | | | |
| Trans Fat (g) | 0 | 0 | 0 | 0 | 0 |
| Carbohydrate, Total (g) | 65 | 66.4 | 68.4 | 64.1 | 64 |
| Carbohydrate, Available (g) | 46.6 | 50.3 | 51.0 | 46.2 | 50.1 |
| Total Dietary Fiber (g) | 24.7 | 22.2 | 24.0 | 26.4 | 19.9 |
| Insoluble fiber | 18.4 | 16.1 | 17.4 | 17.9 | 13.9 |
| Soluble fiber | 6.3 | 6.1 | 6.6 | 8.5 | 6.0 |
| Sugars (HPLC), in (g) | | | | | |
| Fructose | 0 | 0 | 0 | 0 | 0 |
| Glucose | 0 | 0 | 0 | 0 | 0 |
| Sucrose | 3.84 | 3.64 | 2.39 | 4.02 | 3.66 |
| Maltose | 0 | 0 | 0 | 0 | 0 |
| Lactose | 0 | 0 | 0 | 0 | 0 |
| Raffinose | 0.21 | 0.26 | 0.35 | 0.33 | 0.25 |
| Stachyose | 2.28 | 2.00 | 2.91 | 2.53 | 2.08 |
| Protein (g) | 23.1 | 22.4 | 20.8 | 24.4 | 24.6 |
| Vit A Retinol (IU) | 100 | 100 | 100 | 100 | 100 |
| (less than) | | | | | |
| Vit C Total (mg) | 2.56 | 3.1 | 2.98 | 3.16 | 3.04 |
| Vit E (IU) (less than) | 0.1 | 0.1 | 0.1 | 0.1 | 0.1 |
| Vit B1 (Thiamin) (mg) | 0.2 | 0.4 | 0.31 | 0.27 | 0.19 |
| Minerals and Metals | | | | | |
| Sodium (mg) | 37.2 | 43.6 | 29.0 | 27.1 | 30.7 |
| Potassium (mg) | 919 | 927 | 1080 | 1000 | 750 |
| Calcium (mg) | 197 | 292 | 188 | 259 | 310 |
| Magnesium (mg) | 130 | 121 | 103 | 126 | 125 |
| Phosphorus (mg) | 403 | 440 | 417 | 520 | 481 |
| Folic Acid, Total | 76.4 | 107 | 132 | 132 | 127 |
| (μg) | | | | | |
| Zinc (mg) | 2.66 | 2.52 | 2.37 | 2.01 | 2.27 |
| Iron (mg) | 5.17 | 5.45 | 5.87 | 5.15 | 5.22 |
| Copper (mg) | 0.715 | 0.773 | 0.628 | 0.936 | 0.625 |
| Niacin (mg) | 1.02 | 1.52 | 1.39 | 1.49 | 1.51 |
| Moisture (%) | 6.91 | 5.99 | 5.98 | 5.79 | 6.43 |
| Ash (%) | 2.766 | 2.959 | 2.950 | 3.160 | 2.745 |
| Cholesterol (mg) | 0 | 0 | 0 | 0 | 0 |

TABLE 2
Properties of bean products.

| Bean | Moisture | Protein | Dietary | Fat | Carbohydrates | Calories per |
|---|---|---|---|---|---|---|
| Type | (%) Max | (%) | Fiber (%) | (%) | (%) | 100 grams |
| Pinto Bean | 9.5 | 22.3 | 23.0 | 1.8 | 63.1 | 292 |
| powder | | | | | | |
| Black Bean | 9.5 | 24.6 | 22.2 | 2.0 | 65.6 | 321 |
| powder | | | | | | |
| Small Red | 9.5 | 23.6 | 22.5 | 1.8 | 67.2 | 323 |
| Bean powder | | | | | | |
| Navy Bean | 9.5 | 22.3 | 27.7 | 2.0 | 64.8 | 367 |
| powder | | | | | | |
| Great Northern | 9.5 | 23.0 | 22.3 | 2.2 | 67.4 | 325 |
| Bean powder | | | | | | |
| Dark Red | 9.5 | 23.3 | 23.8 | 1.6 | 62.1 | 356 |
| Kidney Bean | | | | | | |
| pieces | | | | | | |
| Light Red | 9.5 | 23.3 | 23.8 | 1.6 | 62.1 | 356 |
| Kidney Bean | | | | | | |
| pieces | | | | | | |
| White Kidney | 9.5 | 25.3 | 23.8 | 1.8 | 61.7 | 298 |
| Bean pieces | | | | | | |
| Pink Bean | 9.5 | 21.0 | 12.7 | 1.1 | 64.2 | 343 |
| pieces | | | | | | |
| Mayocoba | 9.5 | 26.5 | 19.8 | 1.9 | 62.9 | 320 |
| Bean pieces | | | | | | |

The invention is further explained by use of the following illustrative EXAMPLES.

### EXAMPLES

### Example 1

In one embodiment, the ingredients of Table 3 were mixed together to form a sponge dough. The ingredients were mixed together and allowed to ferment for 18 hours.

TABLE 3

| | Bakers |
|---|---|
| Ingredients | Percentage (%) |
| Pastry flour, SWAN brand pastry flour having a | 19.80% |
| protein content of about 9.0%, available from ADM | |
| Milling of Overland Park, Kansas | |
| Cake flour, TEA TABLE brand cake flour having a | 24.80 |
| protein content of about 8.5%, available from ADM | |
| Milling of Overland Park, Kansas | |
| Dehydrated Navy bean powder, available from Archer | 24.80 |
| Daniels Midland Company of Decatur, Illinois | |
| RED STAR dry active yeast | 0.15 |
| Shortening, interesterified soybean oil 76-240-0 | 5.91 |
| available from Archer Daniels Midland Company of | |
| Decatur, Illinois | |
| Diastatic malt syrup, #100 HD available from | 3.00 |
| International Molasses Corporation | |
| Water | 40.60 |

Once fermented, the sponge dough was mixed with the ingredients of Table 4 to form the dough. The dough was laminated using 3 folds, 3 times where the dough was rolled into a rectangle to a thickness of between about 0.5 to 1 inch, folded over in thirds, flattened into the rectangle again, and this process was repeated for a total of 3 times. The dough was sheeted with a sheeting machine to a thickness of about 1 mm, docked to put holes in the sheeted dough, cut into squares of about 2 inches by 2 inches, and baked at 425° F. for about 3.5 minutes with 45 seconds of steam.

TABLE 4

| | Bakers |
|---|---|
| Ingredients | Percentage (%) |
| Sponge dough | From Table 3 |
| Cake flour, TEA TABLE brand cake flour having a | 15.30 |
| protein content of about 8.5%, available from ADM | |
| Milling of Overland Park, Kansas | |
| Dehydrated Navy bean powder, available from Archer | 15.30 |
| Daniels Midland Company of Decatur, Illinois | |
| Shortening, interesterified soybean oil 76-240-0 | 5.91 |
| available from Archer Daniels Midland Company | |
| of Decatur, Illinois | |
| Non-fat dry milk | 3.00 |
| Baking soda | 1.11 |
| Salt | 1.62 |
| ULTRALEC ® P brand deoiled lecithin, | 0.30 |
| available from Archer Daniels Midland Company of | |
| Decatur, Illinois | |
| Sodium stearoyl lactylate conditioner and emulsifier | 0.06 |
| FIBERSOL 2 brand soluble fiber, available from | 24.00 |
| Archer Daniels Midland Company of Decatur, Illinois | |

The finished cracker product has the nutrient profile listed in Table 5, wherein one serving size is deemed to be 30 grams (g).

TABLE 5

| Nutrient | Per 30 | g |
|---|---|---|
| Gram weight (g) | 30 | |
| Calories (kcal) | 90 | |
| Calories from fat (kcal) | 20 | |
| Total fat | 2.5 | |
| Saturated fat | 1.00 | |
| Trans fat | 0.00 | |
| Cholesterol | 0.00 | |
| Sodium | 170 | mg |
| Total Carbohydrate | 16 | |
| Dietary fiber | 5 | |
| Sugars | 1 | |
| Protein | 3 | |

### Example 2

In another embodiment, the ingredients of Table 6 were mixed together to form the sponge dough. The ingredients were mixed together and allowed to ferment for 18 hours.

TABLE 6

| | Bakers |
|---|---|
| Ingredients | Percentage (%) |
| Pastry flour, SWAN brand pastry flour having a | 19.80% |
| protein content of about 9.0%, available from ADM | |
| Milling of Overland Park, Kansas | |
| Cake flour, TEA TABLE brand cake flour having a | 24.80 |
| protein content of about 8.5%, available from ADM | |
| Milling of Overland Park, Kansas | |
| Dehydrated Navy bean powder, available from Archer | 24.80 |
| Daniels Midland Company of Decatur, Illinois | |
| RED STAR dry active yeast | 0.15 |
| Shortening, interesterified soybean oil 76-240-0 | 5.91 |
| available from Archer Daniels Midland Company of | |
| Decatur, Illinois | |
| Diastatic malt | 3.00 |
| Water | 40.60 |

Once fermented, the sponge dough was mixed with the ingredients of Table 7 to form the dough. The dough was laminated using 3 folds, 3 times where the dough was rolled into a rectangle to a thickness of between about 0.5 to 1 inch, folded over in thirds, flattened into the rectangle again, and repeated for a total of 3 times. The dough was sheeted with a sheeting machine to a thickness of about 1 mm, docked to put holes in the sheeted dough, cut into squares of about 2 inches by 2 inches, and baked at 425° F. for about 3.5 minutes with 45 seconds of steam.

TABLE 7

| | Bakers |
|---|---|
| Ingredients | Percentage (%) |
| Sponge dough | From Table 6 |
| Cake flour, TEA TABLE brand cake flour having a | 15.30 |
| protein content of about 8.5%, available from ADM | |
| Milling of Overland Park, Kansas | |
| Dehydrated Navy bean powder, available from Archer | 15.30 |
| Daniels Midland Company of Decatur, Illinois | |
| Shortening, interesterified soybean oil 76-240-0 | 5.91 |
| available from Archer Daniels Midland Company of | |
| Decatur, Illinois | |
| Non-fat dry milk | 3.00 |
| Baking soda | 1.11 |
| Salt | 1.62 |
| ULTRALEC ® P brand deoiled lecithin, | 0.30 |
| available from Archer Daniels Midland Company of | |
| Decatur, Illinois | |
| Sodium stearoyl lactylate conditioner and emulsifier | 0.06 |
| FIBERSOL 2 brand soluble fiber, available from Archer | 24.00 |
| Daniels Midland Company of Decatur, Illinois | |

### Example 3

In another embodiment, the ingredients of Table 8 were mixed together and baked to form a basic cookie.

TABLE 8

| | Percentage |
|---|---|
| Ingredients | (%) |
| Cake flour, TEA TABLE brand cake flour having a | 10.13 |
| protein content of about 8.5%, available from ADM Milling | |
| of Overland Park, Kansas | |
| Dehydrated Navy bean powder, available from Archer Daniels | 15.53 |
| Midland Company of Decatur, Illinois | |
| Rice flour | 11.48 |
| Baking powder | 0.52 |
| Salt | 0.37 |
| Sugar | 17.63 |
| Margarine, NOVALIPID brand margarine 106-320 | 5.55 |
| available from Archer Daniels Midland Company of | |
| Decatur, Illinois | |
| ENOVA brand diacylglycerol oil, available from | 5.55 |
| ADM-Kao of Decatur, Illinois | |
| Eggs | 14.64 |
| Skim milk | 4.12 |
| Heavy cream | 0.05 |
| Water | 0.85 |
| Vanilla | 0.87 |
| Orange flavor | 0.22 |
| Dairy flavor | 0.12 |
| FIBERSOL 2 brand soluble fiber, available from Archer | 12.38 |
| Daniels Midland Company of Decatur, Illinois | |
| Total | 100.00 |

### Example 4

In another embodiment, the ingredients of Table 9 were mixed together and cooked to form pancakes.

TABLE 9

| | Percentage |
|---|---|
| Ingredients | (%) |
| Buttermilk | 50.64 |
| Eggs | 15.50 |
| Melted butter | 8.81 |
| Pastry flour | 9.69 |
| Whole wheat flour, fine grind, available from ADM Milling | 4.13 |
| of Overland Park, Kansas | |
| Dehydrated red bean powder, available from Archer Daniels | 2.07 |
| Midland Company of Decatur, Illinois | |
| Dehydrated red bean pieces, available from Archer Daniels | 1.52 |
| Midland Company of Decatur, Illinois | |
| Wheat germ | 1.45 |
| Salt | 0.62 |
| Baking powder | 0.95 |
| Baking soda | 0.71 |
| Sugar | 3.91 |
| Total | 100.00 |

The pancakes have the following nutritional profile per one hundred ten (110) gram serving: 200 calories; 90 calories from fat; 10 grams total fat; 6 grams saturated fat; 0 grams trans fat; 95 mg of cholesterol; 680 mg of sodium; 21 grams of total carbohydrate; 2 gram of dietary fiber; 7 grams of sugars; and 7 grams protein.

### Example 5

In another embodiment, the ingredients of Table 10 were mixed together and cooked to form waffles.

TABLE 10

| | Percentage |
|---|---|
| Ingredients | (%) |
| Pastry flour, SWAN brand pastry flour having a protein | 13.74 |
| content of about 9.0%, available from ADM Milling of | |
| Overland Park, Kansas | |
| Whole wheat flour, fine grind, available from ADM Milling | 10.30 |
| of Overland Park, Kansas | |
| Dehydrated Navy bean powder, available from Archer Daniels | 3.43 |
| Midland Company of Decatur, Illinois | |
| Baking soda | 0.23 |
| Baking powder | 0.47 |
| Salt | 0.61 |
| Sugar | 3.86 |
| Eggs | 15.31 |
| Melted butter | 5.78 |
| Buttermilk | 46.27 |
| Total | 100.00 |

The waffles have the following nutritional profile per eighty-five (85) gram serving: 160 calories; 50 calories from fat; 6 grams total fat; 3 grams saturated fat; 0 grams trans fat; 65 mg of cholesterol; 350 mg of sodium; 21 grams of total carbohydrate; 1 gram of dietary fiber; 5 grams of sugars; and 5 grams protein.

### Example 6

In another embodiment, the ingredients of Table 11 were mixed together and baked to form biscuits.

TABLE 11

| | Percentage |
|---|---|
| Ingredients | (%) |
| Pastry flour, SWAN brand pastry flour having a protein | 31.92 |
| content of about 9.0%, available from ADM Milling of | |
| Overland Park, Kansas | |
| Dehydrated Navy bean powder, available from Archer Daniels | 10.64 |
| Midland Company of Decatur, Illinois | |
| Baking soda | 0.78 |
| Baking powder | 1.17 |
| Salt | 1.53 |
| Shortening | 17.45 |
| Buttermilk | 36.50 |
| Total | 100.00 |

The biscuits have the following nutritional profile per fifty-five (55) gram serving: 180 calories; 90 calories from fat; 10 grams total fat; 4 grams saturated fat; 0 grams trans fat; 0 mg of cholesterol; 540 mg of sodium; 18 grams of total carbohydrate; 3 grams of dietary fiber; 1 gram of sugars; and 4 grams of protein.

### Example 7

In yet a further embodiment, the ingredients of Table 12 were mixed together and baked to form a hand-held sandwich dough or empanada.

TABLE 12

| | Percentage |
|---|---|
| Ingredients | (%) |
| Water | 38.30 |
| Flour, POLAR BEAR brand flour having a protein content | 27.70 |
| of about 10.7% and being a blend of hard winter wheats, | |
| available from ADM Milling of Overland Park, Kansas | |
| Dehydrated Navy bean powder, available from Archer Daniels | 17.90 |
| Midland Company of Decatur, Illinois | |
| Shortening, NOVALIPID brand 106-050 shortening | 7.20 |
| available from Archer Daniels Midland Company of | |
| Decatur, Illinois | |
| KANSAS DIAMOND brand whole wheat flour, available | 5.70 |
| from ADM Milling of Overland Park, Kansas | |
| PROLITE 200 brand wheat protein isolate, available | 2.00 |
| from Archer Daniels Midland Company of Decatur, Illinois, | |
| having at least 85% | |
| protein | |
| Sucrose | 1.00 |
| Salt | 0.20 |
| Total | 100.00 |

The hand-held dough of this example has the following nutritional profile per sixty-three (63) gram serving: 160 calories; 45 calories from fat; 5 grams of total fat; 2 grams of saturated fat; 0 grams trans fat; 0 mg cholesterol; 55 mg of sodium; 23 grams of total carbohydrates; 3 grams of dietary fiber; 1 gram of sugar; and 7 grams of protein.

The present invention has been described with reference to certain exemplary embodiments, legume powders, compositions and uses thereof. However, it will be recognized by those of ordinary skill in the art that various substitutions, modifications or combinations of any of the exemplary embodiments may be made without departing from the spirit and scope of the invention. Thus, the invention is not limited by the description of the exemplary embodiment, but rather by the appended claims as originally filed.

1. A composition comprising:
a dehydrated legume product having an increased amount of dietary fiber on a dry weight basis as compared to a legume from which the dehydrated legume product originates; and
flour;
the dehydrated legume product and the flour being present in the composition in such amounts and processed such that the composition takes the form of a cracker.

2. The composition of claim 1, further comprising an ingredient selected from the group consisting of a pastry flour, a cake flour, yeast, shortening, a malt product, water, a milk product, baking soda, salt, an emulsifier, a dough strengthener, a soluble fiber, and combinations of any thereof.

3. The composition of claim 1, further comprising a corn product, a wheat product, a rice product, a soy product, a barley product, a sorghum product, a sunflower product, a canola product, an oat product, a flax product, a potato product, a buckwheat product, calcium carbonate, sugar, a seasoning, a spice, a texture modifier, a vitamin, a mineral, an edible oil or fat, a leavening agent, a natural or artificial sweetener, a starch, a thickening agent, an insoluble fiber, a cellulose, a nutraceutical, a whey product, and combinations of any thereof.

4. The composition of claim 1, wherein the legume from which the dehydrated legume product originates is a bean.

5. The composition of claim 1, wherein the legume from which the dehydrated legume product originates is selected from the group consisting of yellow peas, green peas, lentils, chickpeas, peanuts, trefoil, Pinto beans, Great Northern beans, Navy beans, Red beans, Black beans, dark or light Red Kidney beans, Fava beans, Green Baby Lima beans, Pink beans, MYASI beans, Mayocoba beans, Small Red beans, Black Eyed Beans, Garbanzo beans, Cranberry beans, White Beans, Rice beans, Butter beans, African Giraffe beans, and combinations of any thereof.

6. The composition of claim 1, wherein thirty grams of the composition comprises at least three grams of dietary fiber.

7. The composition of claim 1, wherein thirty grams of the composition comprises at least five grams of dietary fiber.

8. The composition of claim 1, wherein the dehydrated legume product has a particle size of less than 0.250 mm.

9. The composition of claim 1, wherein at least 95% of the dehydrated legume product passes through an 80 mesh screen.

10. A process for producing a product, the process comprising:
admixing a dehydrated legume product with an ingredient, thus producing a mixture;
fermenting the mixture;
mixing the fermented mixture with a flour; and
baking the fermented mixture and the flour, thus producing a cracker.

11. The process according to claim 10, further comprising laminating the fermented mixture and the flour.

12. The process according to claim 10, further comprising sheeting the fermented mixture and the flour.

13. The process according to claim 12, further comprising docking the sheeted mixture and the flour such that holes are formed.

14. The process according to claim 10, further comprising placing a seasoning, a spice or a combination thereof in contact with the cracker.

15. The process according to claim 10, further comprising placing the cracker in a container.

16. The process according to claim 10, further comprising shipping the cracker from a first location to a second location.

17. A composition comprising:
a dehydrated bean powder having an increased amount of dietary fiber on a dry weight basis as compared to a bean from which the dehydrated bean powder originates;
flour;
shortening;
a malt product; and
an ingredient selected from the group consisting of yeast, a milk product, baking soda, salt, an emulsifier, a dough strengthener, a soluble fiber, and combinations of any thereof;
the dehydrated bean powder, the flour, the shortening, the malt product and the ingredient being present in the composition in such amounts and processed such that the composition takes the form of a cracker.

18. The composition of claim 1, further comprising a seasoning, a spice, a sugar, a preservative or any combinations thereof.

19. A container comprising the composition of claim 1.

20-29. (canceled)
